(19) United States
(12) Patent Application Publication
(10) Pub. No.: US 2005/0250548 A1
(43) Pub. Date: Nov. 10, 2005

(54) Mobile phone image display system

(75) Inventor: Barry White, London (GB)

Correspondence Address: FITZPATRICK CELLA HARPER & SCINTO, 30 ROCKEFELLER PLAZA, NEW YORK, NY, 10112, US

(73) Assignee: CANON EUROPA NV, Amstelveen (NL)

(21) Appl. No.: 11/117,941

(22) Filed: Apr. 29, 2005

(30) Foreign Application Priority Data
Apr. 30, 2004 (GB) 0409730.9

(51) Int. Cl. H04B 1/38

(52) U.S. Cl. 455/566; 455/412.1

(57) ABSTRACT

An image browser program for use on a mobile phone, which, when executed on the mobile phone, performs a method including receiving a list of albums containing a plurality of images from a server system. The album list is determined by the server system to be comprised of albums accessible by a user. The album list is displayed on a display of the mobile phone so that the user can select an album from the album list.

This invention relates to a system for displaying images stored in a database on a mobile phone.

### PRIOR ART

Mobile phones may exchange images with each other using the MMS. Disadvantages of this are that only one image at a time can be sent (the process of sending an MMS message has to be repeated for each image), the images are of low quality (having been taken with an integrated camera on the phone) and that only the sender can initiate transfer of an image.

It is also known (as described later below) to have a web server application that stores images uploaded via the Internet from user's personal computers and allows those, or other users, to view those images.

### SUMMARY OF INVENTION

According to the present invention there is provided a mobile phone image display system, comprising:
a server system comprising an image store and an image server program,
a mobile phone comprising a display and an image browser program,
wherein the server program is arranged to send images from the image store to the mobile phone and the image browser program is arranged to display those images on the display.

The images may be still images or moving images.

The image server program and image store may reside on the same physical server or on different ones from each other. Further either may be located on a single physical computer or be distributed across more than one.

Preferably the server program is arranged to generate thumbnails of a set of images from the image store and to send those to the mobile phone and preferably the image browser program is arranged to display thumbnails from that set on the display of the mobile phone. Preferably the image browser program is responsive to a user selection of one of the thumbnails to display that image on the display. The image browser program may be arranged to display the selected image by requesting it from the server program. Advantageously the server program may be arranged to format the thumbnails according to the mobile phone characteristics.

Advantageously the server program may be arranged to format the image sent to the mobile phone according to the characteristics of the mobile phone.

The image browser program may be arranged to store images sent by the server program in a cache in the mobile phone, and to display a selected image already stored in the cache by accessing it from the cache.

The image browser program may be arranged to display the images on the display without a link to other images included in the display, and the image browser program may be arranged to retrieve and display a further image responsive to user input using a user input control of the mobile phone. The image browser program may be arranged to display a set of thumbnails on the display without a link to other thumbnails included in the display, and the image browser program may be arranged to retrieve and display a further set of thumbnails responsive to user input using a user input control of the mobile phone. Not using a link (such as an WML or HTML link) leaves more room in the display for the image or thumbnail. (Note that number images in a set of thumbnails transferred to the phone at any one time may be one.)

The image browser program may be a J2ME MIDlet.

The image store may store the images organised into album groups. Preferably the server program sends a list of the images in an album group to the mobile phone, and preferably the image browser program displays that list. Preferably the image browser program is responsive to a user selection of an image in a displayed album list to display the selected image.

Advantageously the image browser program may be responsive to a user selection of an image to tag the image for processing according to an action to be selected subsequently. Advantageously the image browser program is responsive to a user selection of an image in a displayed album contents list to tag that image for processing according to an action to be selected subsequently. Advantageously the image browser program may be arranged to responsive to a user selection of an album to tag the album, or the individual images thereof, for processing according to an action to be selected subsequently.

The mobile phone image display system may comprise a digital camera and the system may be arranged to transfer images from the camera to the image store, which images may then be viewed using the mobile phone. The server program may accept an image in an MMS message from the mobile phone and to store that in the image store.

Preferably the mobile phone communicates with the server system using the internet. The mobile phone may be connected to the internet using the GSM communication protocol, or alternatively using the GPRS communication protocol.

The server program may be responsive to a request from the mobile phone to print an image selected by the user, which may be printed according to a set of printing options stored on the server. A plurality of sets of printing options may be stored in the server system, and the request to print an image may include a selection of the set of printing options to be used by the server when printing the image.

The server program may be responsive to a request from the mobile phone to make an image selected by the user available to other users of the server.

The server program may be responsive to a request from the mobile phone to send an image selected by the user to the mobile phone as an MMS image.

Advantageously, the image browser program may be arranged to allow the said selection of an image by allowing the user to Lag The image and to subsequently request these server response. The image browser program may be arranged to allow a plurality of images to be tagged before the server response is selected and to request that response for each of the tagged images.

The mobile phone and the server system may be supplied as separate items. The image browser program may be supplied as a separate computer program product. The server program may be supplied as a separate computer program product. These computer program products may be supplied on a computer readable medium such as a disc, or via download.

### DETAILED EMBODIMENTS

An embodiment of the invention will now be described, by way of example, with reference to the accompanying drawings in which:

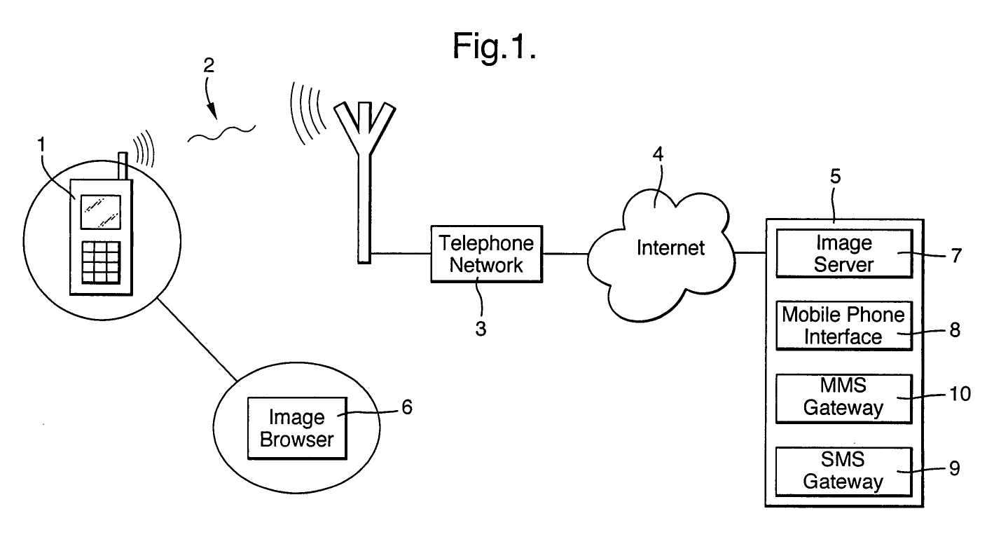

FIG. 1 shows an embodiment of the present invention;

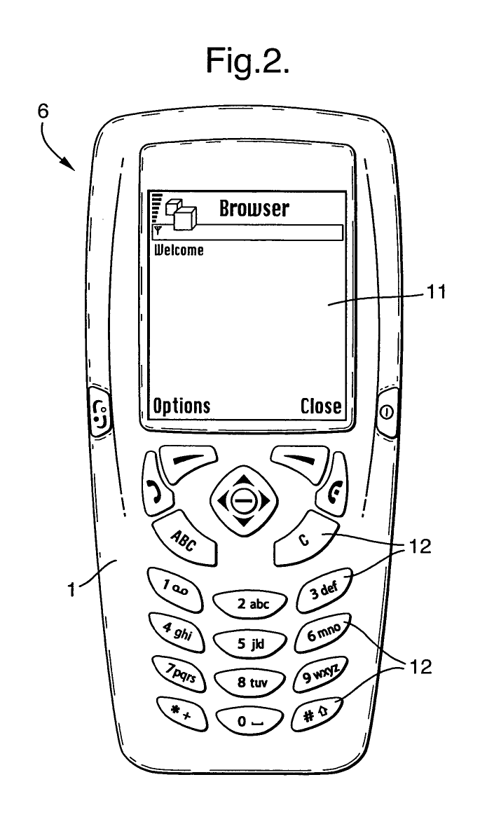

FIG. 2 shows a mobile phone installed with software;

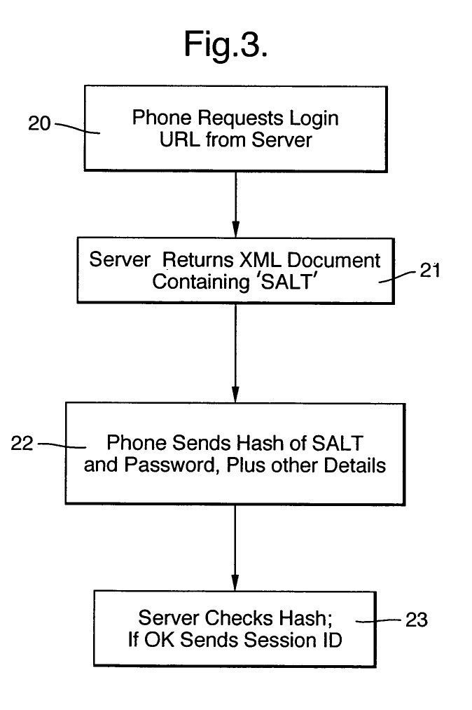

FIG. 3 is a flow chart showing how the mobile phone establishes a session with the server;

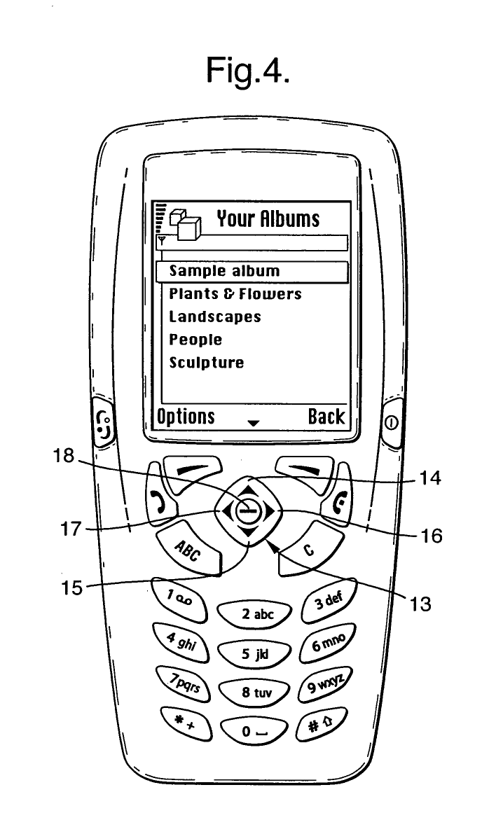

FIG. 4 shows the mobile phone displaying a list of albums;

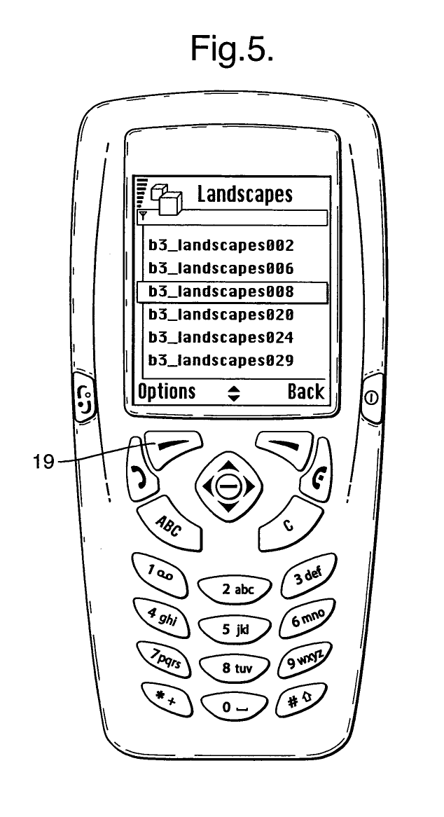

FIG. 5 shows the mobile phone displaying a list of photographs;

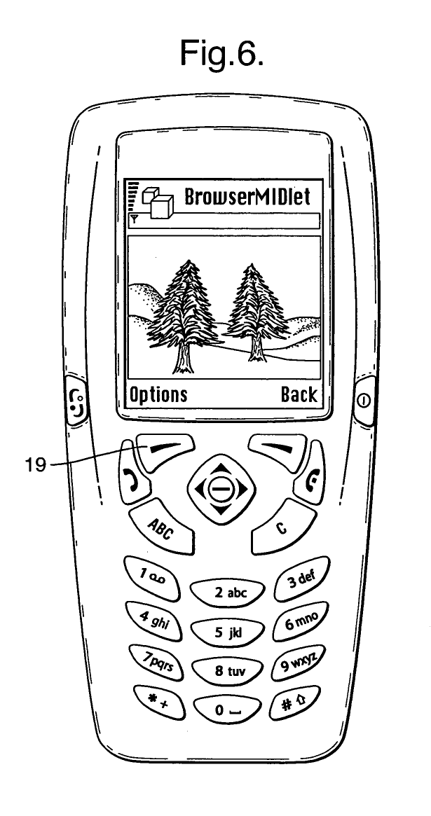

FIG. 6 shows the mobile phone displaying a photograph;

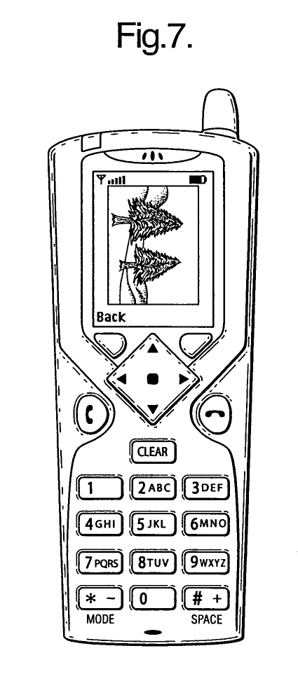

FIG. 7 shows a different mobile phone displaying a photograph;

FIG. 1 shows an embodiment of the system of the invention. A mobile phone 1 is able to communicate, via a radio link 2, with a telephone network 3. The telephone network 4 is connected, via the internet 4, to a server 5, the image server. This allows the mobile phone 1 to send information to and receive information from the server 5.

More specifically, the server 5 is preferably installed with image server software 7 to allow users of digital cameras to store their photographs and to allow them to retrieve them for viewing. The photographs are stored in groups for ease of retrieval; these groups are known as “albums”. Such software is known and is usually implemented as a web application; the photographs can be uploaded to the web application and accessed from a standard personal computer (PC).

FIG. 2 shows the mobile phone 1. The mobile phone 1 has a screen 11, suitable for displaying graphics, and buttons 12 for controlling the mobile phone. The mobile phone also includes (not visible in FIG. 2) a microprocessor based control circuit (including memory, a CPU, etc.) for controlling the mobile phone, amongst other things, to display information and images on the screen 11, communicate with a telephone network, and access data from the internet via the telephone network.

The mobile phone also incorporates a standard secure Java environment, J2ME. This allows applications, called Java “MIDlets”, to be installed upon the mobile phone. A MIDlet is a kind of Java application program that runs on a “Micro Information Device”, of which the mobile phone 1 is an example. The normal method of installation of MIDlets is to download them from the internet onto the mobile phone, via the telephone network. As can be seen in FIGS. 1 and 2, the mobile phone 1 has an installed application, an image browser 6 in accordance with the invention. This is installed on the phone 1 in the normal manner.

For the invention, the server is provided with an additional software module 8 to service requests, via the internet, from a mobile phone with the image browser 6, for example, the mobile phone 1. This allows such a mobile phone, amongst other things, to display photographs stored on the server 5 (utilising the image server software 7). However server 5 could simply be provided with software to service mobile phones alone, in other words without the full web application 7 for servicing general internet users.

It is not limited to still digital images, but any other kind of image for example movies.

During use of the image browser application 6, the mobile phone accesses information from the internet. The mobile phone is configured, for this, to access the internet in a standard way. Two standard (and preferred) connection methods are GSM, where the user pays according to the time they spend connected, and GPRS, where the user pays according to the amount of data download. Usually, a connection time out lasts about 30 seconds, after which the internet connection is dropped. Optionally, in order to increase the reliability of the connection and to avoid any undesirable disconnection, the image browser application 6 can be configured to send a request to the server 5 on a regular basis, for example every 20 seconds, in other words more frequently than the usual connection time out. The request is for a tiny web page on the server, keeping the data transferred to a minimum. After a certain time without activity, for example 3 minutes, the image browser application 6 causes the mobile phone to end the connection. However, to avoid the connection being kept open against the wishes of the user of the mobile phone, the connection is preferably controlled by the mobile phone according to its standard settings.

To operate the installed MIDlet 6 the user operates the buttons 12 of the mobile phone. Although different models of phone have different sets of buttons, this is dealt with by the J2ME environment which maps the physical buttons of any particular phone to abstract buttons, or functions, with which the application interacts. The use of the buttons of the mobile phone by the image browser means that no WML links (WML is the format of the files transferred by the WAP protocol commonly used by mobile phones), which are normally used when browsing the internet using a mobile phone, need to be displayed on the screen; in other applications WML links are commonly used to allow the user to request the next page of information. This allows the image browser to use more of the screen for displaying information and photographs. Preferably, a navigation or direction control 13 is used to browse through the various pages. The direction control may be, for example, a diamond shaped button that provides signals indicating which of its four corners have been pressed, a group of four direction buttons (these are often also arranged in a diamond), or a joystick. The use of such a control is also more user friendly.

FIG. 3 is a flow chart showing how the application 6 on the mobile phone and server 5 establish a session. The mobile phone contains details of the users account name and password to be used to login to their account upon the server. These will have previously been keyed in by the user on the phone to the application following a registration procedure, which, to keep the application 6 simple, the user will have carried out on a PC connected to the server by the Internet. Alternatively, registration through the mobile phone is also possible.

First, the mobile phone requests the login initiation URL from the server (step 20). The server returns an XML document containing a “salt” (step 21). A salt is a string of characters to be used by the mobile phone which the server will accept, for the purpose of establishing a session, for a limited time only (for example half an hour). The application concatenates the password with the salt, and hashes the result (for example using the well known MD5 message-digest algorithm). The mobile phone then sends the hash, username and other details (for example, the screen size, which image formats are supported by the mobile phone, for example whether the mobile phone supports JPEG format graphics, how many colours the mobile phone can display) to the server (step 22). The server checks the hash to see if it is valid by checking that it is equal to the hash of the salt concatenated with the user's password (taken from its database of user account details). If it is valid, the server sends a session ID to the mobile phone to use for the duration of the session (step 23). This system provides a simple encryption for the login adapted to a phone with low processing power.

Alternatively HTTPS can be used for exchange of data for mobile phones that support that.

The mobile phone then uses the session ID in its future requests to the server, in order to identify the session between itself and the server. When the mobile phone makes a request to the server, it makes an http “GET” request using a URL; the session ID is included in the “GET” portion of the URL. The “GET” portion of a URL follows a question mark, and is found after the main part of the URL, for example the string “sessionID=12345” is the GET portion in the URL “www.cgiserver.com/?sessionID=12345”. The session ID expires after a fixed amount of time, for example 3 hours.

Once a session has been established, the server sends a list of album titles and IDs for those albums to the mobile phone, as an XML document. These are the albums available to the user. (The list is determined by the server to be those albums belonging to the user plus any that other users have decided to share with the user.) The mobile phone displays the list of album titles, for example as shown in FIG. 4. The user then selects a particular album for example using the navigation control 13. Other buttons of the phone could be used, however. (For example, the highlighted list item changes as the user presses the up 14 and down 15 buttons of the control 13, and the user requests the contents of the album by pressing the select button 18, which in the illustrated example is in the centre of the control 13.) The browser application 6 sends in response to the user pressing the select button a request (an http GET) for that album containing the album ID, and the server sends a list of photograph titles and IDs for the photographs in that album to the mobile phone, again as an XML document. FIG. 5 shows the phone 1 displaying such a list of photograph titles. Alternatively, the server can send a list of thumbnail images (small graphics files) and photograph IDs, again as an XML document, for the mobile phone to display. The thumbnails will be formatted by the server according to the details of the mobile phone established during login (for example thumbnail resolution, number of thumbnails to display per page, etc.). The server will initially only send thumbnails for a limited number of images (say the first 10), and will indicate that there are more thumbnails to be sent.

Next the user selects a particular photograph. This is done for example by selecting the desired photograph from a list using the same method as used for selecting an album; or, if the phone is displaying thumbnails in a grid, the highlighted item will also change as the user presses the right 16 and left 17 buttons of the control 13 in addition to up and down. If there are more thumbnails available from the server, the mobile phone will indicate that to the user (for example with an arrow on the display). The user can then use the navigation control 13 to indicate that he wishes to view further thumbnails, for example by pressing the down 15 button while on the bottommost thumbnail displayed (this avoids the need to include a WML link in the screen). The mobile phone then sends a request to the server to send the next set of thumbnails.

Once a photograph is selected the application sends a request containing the photograph's ID, and the server sends the photograph, suitably formatted, to the mobile phone, and it is displayed, as shown in FIG. 6. The server, if necessary, reformats the photograph to be sent from an original photograph version stored on the server according to the details of the mobile phone sent to it during the login process. For example, the server will fit the image to the size of the mobile phone screen, and may rotate the image to better fit the shape of the mobile phone screen. FIG. 7 shows an example of a photograph rotated so as to fit on a mobile phone screen with different dimensions. The server may also adjust the representation of the photograph to match the capabilities of the mobile phone, for example to adjust the numbers of bits used to represent the colour of pixels, or to convert the image into an encoding format supported by the mobile phone (for example JPEG, PNG).

The user can browse directly from one image to another without going back to the list of image titles, for example using the navigation control 13, avoiding the need to include a WML link in the screen displayed.

In order to reduce the amount of data that must be transmitted to the mobile phone, the application is able to cache in the mobile phone the album and photograph lists and images it receives. As there is only a limited amount of space available for caching, when this space is becoming full the least recently used item is discarded from the cache.

If the mobile phone is connected to the internet using GSM, and so the user pays for the time connected, in order to save money the mobile phone downloads the available photographs in the background while the user is using the image browser application. If the mobile phone is connected using GPRS, and so the user pays for the data downloaded, the application only downloads photographs when specifically requested by the user.

As well as being displayed, the photographs can be tagged in the image browser application 6 by the user, for example using the screen menu button 19 next to the word “Options” displayed on the screen as illustrated on FIG. 6. Images can also be tagged in the list of images in an album (FIG. 5), or in the thumbnail display, again using the “Options” button 19. The server can then be requested by the application to perform services related to the tagged photographs. Alternatively a whole album may be tagged and the request then is applied in respect of each of the images in that album. (Equivalently, either the album itself or the individual images of the album may be tagged for that purpose.)

The user can request that tagged photographs be printed and sent to the user. The user's printing preferences are stored with the user's account details on the server.

The user can share tagged photographs with other users. To do this the user can request that the tagged photographs are added/deleted from the list if those accessible to one or more users. Alternatively the user can select a whole album to be shared. The server is informed of the identity of the other users (phone number, email address, etc.) and of the images or albums they can access. The server then sends an email to the other users notifying them that there are photographs that can be viewed. Alternatively a text message can be sent to them using the SMS gateway 9 on the server 5 or on another server. In any case, the other users can then view the photographs via the internet or using their mobile phone (either with the same MIDlet installed on their phone or if they do not have that installed using a standard WAP browser if the system is also provided with a suitable WAP server application on server 5). The email or SMS message may contain a link (a HTML or WML link) allowing the image to be retrieved. The shared photographs will be made available to such users automatically by the server. When such users themselves have an account on the server, their respective albums will appear in the other users' album list.

The user can also request the server to send them a photograph by MMS (multimedia messaging service) using MMS gateway 10 on the server 5 or another server. This allows them, for example, to use the photograph as a background on their mobile phone, which is otherwise not possible (J2ME does not allow it; in fact J2ME does not allow applications to interact with any of a mobile phone's normal functions, such as making phone calls etc.).

J2ME also prohibits access by an application to any camera integrated into the mobile phone 1. In the present invention, however, the user can also upload photographs from their mobile phone to the server, using MMS. The server 5 is able to recognise user as the sender of the MMS using the number from which it was sent; the photograph is stored in a default album of that user.

The user can also use the image browser to display a slideshow of photographs from the server. For example, instead of browsing through the images using the navigation control, the user can select a “slideshow” option via the option button 19. The mobile phone will then automatically browse through the various images of an album; the timing of the slideshow can be set from the mobile phone. The slideshow can be stopped and resumed using mobile phone buttons.

1-66. (canceled)

67. A computer-readable storage medium storing an image browser program for use on a mobile phone, which, when executed on the mobile phone, performs a method comprising the following steps:
receiving a list of albums containing a plurality of images from a server system, wherein the album list is determined by the server system to be comprised of albums accessible by a user, and
displaying the album list on a display of the mobile phone so that the user can select an album from the album list.

68. The computer-readable storage medium as claimed in claim 67, wherein the method performed by the image browser program further comprises the following steps:
retrieving from the server system, in response to a user selection of an album from the album list, a list of images in the selected album, and
displaying the image list on the display so that the user can select an image from the image list.

69. The computer-readable storage medium as claimed in claim 68, wherein the method performed by the image browser program further comprises the step of displaying the image list as thumbnails.

70. The computer-readable storage medium as claimed in claim 68, wherein the method performed by the image browser program further comprises the following steps:
receiving the selected image from the server system, in response to a user selection of an image from the image list, and
displaying the selected image on the display.

71. The computer-readable storage medium as claimed in claim 70, wherein the method performed by the image browser program further comprises the steps of displaying the selected image on the display without a link to other images included in the display, and retrieving and displaying further images in response to a user input using user input controls of the mobile phone.

72. The computer-readable storage medium as claimed in claim 67, wherein the method performed by the image browser program further comprises the following step:
tagging an image or album, or individual images contained therein, in response to a user selection of an image or album from an image list or the album list, for processing according to an action to be selected subsequently.

73. The computer-readable storage medium as claimed in claim 69, wherein the method performed by the image browser program further comprises the step of:
formatting each displayed image, or thumbnail to characteristics of the mobile phone.

74. The computer-readable storage medium as claimed in claim 70, wherein the method performed by the image browser program further comprises the following steps:
storing images sent by the server system in a cache, and
displaying a selected image already stored in the cache by accessing it the selected image from the cache.

75. The computer-readable storage medium as claimed in claim 67, wherein the album list is determined by the server system to be comprised of albums belonging to a user.

76. A method of displaying images on a display of a mobile phone, the images stored on a server system in at least one album containing a plurality of images, the method comprising the steps of:
receiving a list of albums from the server system, wherein the album list is determined by the server system to be comprised of albums accessible by a user, and
displaying the album list on the display so that the user can select an album from the album list.

77. A method of displaying images as claimed in claim 76, further comprising the steps of:
retrieving from the server system, in response to user selection of an album from the album list, a list of images in the selected album, and
displaying the image list on the display so that the user can select an image from the image list.

78. A method of displaying images as claimed in claim 77, wherein the image list is displayed as thumbnails.

79. A method of displaying images as claimed in claim 77, further comprising the steps of:
receiving the selected image from the server system, in response to user selection of an image from the image list, and
displaying the selected image on the display.

80. A method of displaying images as claimed in claim 79, wherein the selected image is displayed on the display without a link to other images included in the display, and further images are retrieved and displayed in response to a user input using user input controls of the mobile phone.

81. A method of displaying images as claimed in claim 76, further comprising the step of:
tagging an image or album, or individual images contained therein, in response to a user selection of an image or album from an image list or the album list, for processing according to an action to be selected subsequently.

82. A method of displaying images as claimed in claim 78, further comprising the step of:
formatting each displayed image or thumbnail to characteristics of the mobile phone.

83. A method of displaying images as claimed claim 76, wherein the album list is determined by the server system to be comprised of the albums belonging to a user.

84. A method of displaying images as claimed claim 79, further comprising the steps of:
storing images sent by the server system in a cache, and
displaying a selected image already stored in the cache by accessing it the selected image from the cache.

85. A mobile phone comprising a display and an image browser program, wherein the image browser program is arranged to:
receive a list of albums containing a plurality of images from a server system, wherein
the album list is determined by the server system to be comprised of the albums accessible by a user, and
display the album list on the display so that the user can select an album from the album list.

86. A mobile phone as claimed in claim 85, wherein the image browser program is arranged to:
retrieve from the server system, in response to a user selection of an album from the album list, a list of images in the selected album, and display the image list on the display so that the user can select an image from the image list.

87. A mobile phone as claimed in claim 86, wherein the image list is displayed as thumbnails.

88. A mobile phone as claimed in claim 86, wherein the image browser program is arranged to:
receive the selected image from the server system, in response to a user selection of an image from the image list, and
display the selected image on the display.

89. A mobile phone as claimed in claim 88, wherein the image browser program is arranged to display the selected image on the display without a link to other images included in the display, and to retrieve and display further images in response to a user input using user input controls of the mobile phone.

90. A mobile phone as claimed in claim 85, wherein the image browser program is arranged to:
tag an image or album, or individual images contained therein, in response to a user selection of an image or album from an image list or the album list, for processing according to an action to be selected subsequently.

91. A mobile phone as claimed in claim 87, wherein the image browser program is arranged to:
format each displayed image or thumbnail to characteristics of the mobile phone.

92. A mobile phone as claimed in claim 88, wherein the image browser program is arranged to:
store images sent by the server system in a cache, and
display a selected image already stored in the cache by accessing it the selected image from the cache.

93. A mobile phone as claimed in claim 85, wherein the album list is determined by the server system to be comprised of the albums belonging to a user.

94. A mobile phone as claimed in claim 85, wherein the image browser program is a J2ME MIDlet.

95. A mobile phone as claimed in claim 85, wherein the mobile phone communicates with the server system using the internet.

96. A mobile phone as claimed in claim 95, wherein the mobile phone is connected to the internet using the GSM or GRPS communication protocol.

97. A mobile phone as claimed in claims 85, wherein the image browser program is arranged to send a request to the server system to make an image selected by the user available to other users of the server system.

98. A mobile phone as claimed in claim 86, wherein the image browser program is arranged to send a request to the server system to send an image selected by the user to the mobile phone as an MMS image.

99. The computer-readable storage medium as claimed in claim 67, wherein the images comprise at least one of still images and moving images.

100. The computer-readable storage medium as claimed in claim 69, wherein the method performed by the image browser program further comprises the following steps:
receiving an image from the server system, in response to a user selection of a thumbnail from the image list, the received image corresponding to the selected thumbnail, and
displaying the selected image on the display.

101. The computer-readable storage medium as claimed in claim 72, wherein the action to be selected subsequently includes at least one of printing the tagged image or album, and sharing the tagged image or album with other users.

102. The computer-readable storage medium as claimed in claim 68, wherein the method performed by the image browser program further comprises the step of displaying selected images on the display as a slideshow in which each image is displayed for a predetermined time.

103. The computer-readable storage medium as claimed in claim 73, wherein the characteristics include at least one of screen size information, image format information, color information, and resolution information.

104. The computer-readable storage medium as claimed in claim 69, wherein the method performed by the image browser program further comprises the steps of displaying a partial list of thumbnails, and indicating to the user that further thumbnails are available.
